(19) United States
(12) Patent Application Publication
(10) Pub. No.: US 2019/0010907 A1
(43) Pub. Date: Jan. 10, 2019

(54) COMPONENT OF A HYDRAULIC DEVICE, IN PARTICULAR OF A FUEL INJECTION SYSTEM FOR INTERNAL COMBUSTION ENGINES

(71) Applicant: Robert Bosch GmbH, Stuttgart (DE)

(72) Inventors: Andreas Rehwald, Bietigheim-Bissingen (DE); Atanas Dimitrov, Vaihingen/Enz (DE); John Seifert, Kalkaska, MI (US); Klaus Lang, Stuttgart (DE); Waldemar Nussbaecher, Ludwigsburg (DE)

(21) Appl. No.: 16/065,945

(22) PCT Filed: Dec. 2, 2016
(86) PCT No.: PCT/EP2016/079577

§ 371 Date: Jun. 25, 2018

(30) Foreign Application Priority Data
Dec. 29, 2015 (DE) 10 2015 226 795.4

(51) Int. Cl. F02M 55/00; F02M 55/02

(52) U.S. Cl. CPC F02M 55/005; F02M 55/02; F02M 2200/9053; F02M 2200/8084; F02M 2200/8061

(57) ABSTRACT

A component of a hydraulic device which is used in particular as a fluid line of a hydraulic high-pressure device and/or of a fuel injection system for internal combustion engines, includes a tubular base body. At least one part of the base body is formed from a material based on at least one duplex steel. Furthermore, a hydraulic device is provided having at least one such component.

### BACKGROUND INFORMATION

The present invention relates to a component of a hydraulic device, in particular a fluid line of a hydraulic high-pressure device and/or a fuel injection system for internal combustion engines. The present invention specifically relates to the field of fuel injection systems of motor vehicles in which highly pressurized fuel is preferably injected directly into the combustion chambers of an internal combustion engine.

A fuel injection system is described in U.S. Patent Application No. 2010/0264231 A1. Here, multiple components, in particular a fuel pump, a fuel rail, and injectors are provided which are connected to one another via suitable lines.

In a fuel injection system, such as the one described in U.S. Patent Application 2010/0264231 A1, a conveyance of a fuel is necessary from a tank to the injectors via a pump and, if necessary, a fuel rail. For this purpose, more or less long connection paths are necessary with regard to the particular installation space specifications at the internal combustion engine, in particular in an engine compartment. A line which is used to bridge such paths must then also potentially include bendings, kinks or the like at suitable points in order to correspond to the spatial conditions.

### SUMMARY

An example component according to the present invention may have the advantage that an improved implementation and functionality are made possible. In particular, an adaptation to the geometric specifications which are necessary, for example, due to an installation space or required connecting points may be achieved in an improved manner.

The measures described herein make advantageous refinements of the example component.

The component may involve a fluid line, in particular, which conveys a fluid, in particular a liquid fluid, during operation. Specifically, the fluid line may be suitable for a high-pressure device via which a highly pressurized fluid is conveyed during operation. Specifically, the component may be a part of a fuel injection system for internal combustion engines. In the case of applications in motor vehicles, in particular, such a component may, however, also be used in a different device, for example in a metering device for metering a fluid which may be used, for example, to improve exhaust gas values, in particular through an exhaust aftertreatment.

Advantageously, fluid lines may, in particular, be implemented to bridge short and long paths, a very flexible adaptation to installation space and assembly specifications being possible. For example, suitable holding means, in particular holding brackets, may be provided to fasten the component. In addition to the mechanical fastening this may also serve to reduce vibrations. For the purpose of connecting to such holding brackets, which are in general necessary in particular in the case of long fluid lines, suitable deformations are potentially necessary or at least advantageous. For example, an easy assembly and disassembly of the fluid line may be advantageous for a good adaptability to the internal combustion engine.

Moreover, end closures or branch duct closures or connection interfaces may be necessary. A corresponding adaptation and, if necessary, an integrated or a partially integrated implementation may be made possible in this case. For example, the two ends of a fluid line may be formed with regard to a sealing connection interface. In this case, one end or both ends of the fluid line may be advantageously designed to be ready for connection. This simplifies the assembly and additionally prevents assembly errors. As a result, the leakage tightness of the interface may be ensured, in particular, in an improved manner.

To form an interface in a completely or partially integral manner, a diameter and a wall thickness of the base body may be in particular partially reduced in order to enable the forming. If, for the purpose of implementing the interface, a part of the tubular base body which is connected to a connecting element through soldering, welding, gluing or crimping, for example, is used, the diameter and the wall thickness may be reduced at the part at least sectionally in order to enable a geometric adaptation to the connecting element used for the interface and/or other additional elements.

A stainless austenitic steel, which may be used partially in any case as the material for the component, in particular a fluid line, and for the interface parts, enables a good corrosion resistance as compared to, for example, a non-stainless steel in the case of which a special coating would be necessary in this regard to meet the corrosion resistance of the parts.

Due to the limited installation space at the internal combustion engine and the required line length, the geometry of the line cannot be substantially changed in the present application for the purpose of improving the stiffness of the line or the stiffness at an interface, for example. For example, a special guidance of the fluid line which may be achieved in this regard by correspondingly bending the fluid line may be necessary with regard to the internal combustion engine and its add-on components as well as other components accommodated in the engine compartment. Moreover, the bending process or the manufacture of the fluid line itself together with its interfaces and, if necessary, additional elements, which are used, for example, for connecting, represent limitations with regard to larger dimensions and wall thicknesses. Specifically, changes, in particular reductions, of a diameter may be necessary. Sometimes, predefined assembly or connecting geometries, which are predefined, for example, at a pump or at a fuel distributor as the connection partners, and, potentially, also production-related boundary conditions, for example with regard to the assembly tools, such as electric screwdrivers, assembly aids, and test devices, which may be required for checking the leakage tightness, for example, do not allow for an additional increase in the line dimensions.

In order to increase the static and dynamic stiffness of the fluid line, the dimensions or the wall thickness of the fluid line may be increased at least partially. An increased stiffness is in general necessary when the loads acting on the fluid line increase, for example, the hydraulic load due to an increase in the fluid pressure of the hydraulic system or the mechanical loads due to masses excited by oscillations. In particular, an increase in the fuel pressure may be desirable to improve a combustion.

By using a material based on at least one duplex steel, the stiffness and the fatigue strength of the fluid line may be improved, without increasing its dimensions, making the manufacturability more difficult or impairing the chemical resistance. In particular, a desirable fluid through-flow per time unit may be implemented by using a flexible fluid line having small dimensions, the dimensions and the mass or the weight not requiring an increase.

A duplex steel is characterized by a mixed microstructure made of austenitic and ferritic components. The crystallographic structure may also be affected by additives in this case. For example, nickel (Ni), chromium (Cr), molybdenum (Mo), nitrogen (N), and others, such as copper (Cu), may be used as additives, nickel in particular being capable of having an impact on the crystallographic structure. The typical microstructure of a duplex steel represents a basis for the improved material properties.

It is understood that the advantages named above based on the fluid line and possible embodiments and refinements are also implementable in a corresponding manner in the case of other components of a hydraulic device. In particular, the stiffness and the service life of the component may be improved and a fatigue may be reduced.

Possible duplex steels, on which the material for the base body may be based, represent steels having the international steel number EN 1.4162, EN 1.4362, EN 1.4662, EN 1.4462, EN 1.4410 and comparable types of steel. Here, it is also understood that such a duplex steel may be suitably modified, if necessary, in particular by varying the proportions of the intended additives and/or by omitting at least one additive and/or by adding at least one additional additive. Furthermore, it is in principle also possible that the part of the base body which is formed from a material based on at least one duplex steel, is additionally coated. However, the duplex steel is preferably selected in such a way that no additional coating is necessary in order to meet the requirements with regard to a corrosion resistance, for example.

In order to implement a closure, in particular an end closure, or a connection, in particular an end connection, different shapes, geometries or wall thicknesses may be implemented, without impairing the manufacturability. This allows for adaptations to different interfaces. The implementation of the part of the base body from the material based on at least one duplex steel is thus advantageously suitable for the refinements in accordance with the present invention.

If a duplex steel is used for the component, an optimized corrosion resistance may be achieved which is, for example, advantageous in the case of a fuel line. Here, it is particularly advantageous according to a refinement in accordance with the present invention that the part of the base body is formed completely or essentially from one or multiple duplex steel(s).

The component may be designed completely from the material based on at least one duplex steel. The base body may, in this case, be specifically completely formed from this material. It is, however, also possible that one or multiple parts of the base body are formed from such a material. The specification that a part of the base body is formed from a material based on at least one duplex steel is to be understood in this case in such a way that this includes a merely partial formation of the base body from such a material as well as a complete formation of the base body form such a material.

One refinement in accordance with the present invention may have the advantage that a deformation of the base body may be advantageously carried out at interfaces, for example, or at a closure. In addition to a good manufacturability, an optimal corrosion resistance may be achieved in this case at the part which is subjected to corresponding loads due to its interface function, for example.

In one of the refinements in accordance with the present invention, a connecting element may be implemented which also has the advantageous properties, which result from the duplex steel, for implementing an interface or the like. In this case, integral and/or form-locked connections may be moreover implemented between the base body and the connecting element. Examples of such integral and/or form-locked connections which are particularly advantageous are also provided in accordance with the present invention. In one possible refinement of the present invention, the connecting element may be based on at least one duplex steel or a combination of a connecting element based on austenitic steel and a part of the base body based on at least one duplex steel may also be implemented.

The implementation of the sealed connections between the connecting partners which are formed from duplex steels or from a duplex steel and an austenitic steel in the area of the connection, may take place via a thermal connection process. For example, local soldering may be used which may be made possible in particular by local inductive heating. Welding may advantageously also be used as a thermal connecting process which may be carried out in a kiln, for example. An integral connection may be implemented in this or in another way. However, reshaping and/or folding and/or crimping are possibilities to establish a connection by way of a form-locked connection. By taking into account the particular application, gluing may also be used to establish the connection. It is understood that a combination of different connection processes may in principle also be used. In particular, a form-locked connection, such as the one achievable by crimping, may serve as a preparatory stage for a thermal connecting process.

In one refinement in accordance with the present invention, a connection may be advantageously implemented which is well manufacturable in terms of processing and which is highly stressable during operation. The recess of the connecting element is not necessarily cylinder-shaped in this case. In one additional refinement in accordance with the present invention, a stop or a limitation may be in particular predefined at a step of the stepped bore, when the part is inserted into the recess of the connecting element for the purpose of subsequently establishing the connection. The stepped bore may be axially symmetrical in this case. However, other designs, in particular rotatably fixed designs, are also possible. Furthermore, one advantageous embodiment which is suitable in particular for fluid lines designed as connecting lines, if these are designed in a corresponding manner at both their ends, is possible with the aid of one refinement according to the present invention. This makes it possible, for example, to connect a pump, in particular a high-pressure pump, and a fuel distributor to one another.

Advantageous refinements according to the present invention may be implemented particularly well especially if a material is used which is based on at least one duplex steel. In particular, not only round, in particular circular, fluid lines may be manufactured. But also fluid lines having a square or another polygonal cross section may be easily implemented, thus resulting in a wide range of applications due to the flexible implementation possibility.

As a result of the good formability of the duplex steel, the manufacture of the fluid line, a bending or a similar deformation of the fluid line, locally required or desirable geometry modifications or the like may be implemented economically in terms of processing. This also applies, as already mentioned, to other components. Possible applications include a reduction of the diameter for connection interfaces or other interfaces having small geometries, the reduction of the diameter taking place in particular continuously or at one step.

Seamless, drawn fluid lines, welded fluid lines having a round design and those having a round as well as non-round design of the cross section are advantageous examples which may be manufactured due to the material based on at least one duplex steel.

A non-symmetric design of the cross section of the fluid line, which is potentially advantageous in the particular application, may also be implemented. Here, geometric and/or material-related differences may be implemented. For example, different stiffnesses in different radial directions of the cross section may be advantageous in certain applications. In this way, a good bending property, i.e., a minor stiffness, and a high stability, i.e., a great stiffness, which are predefined in different radial directions may be achieved. In this way, it is possible, for example, that a fluid line is designed having a particularly small bending radius in one bending direction and, at the same time, deformations, such as the ones which may be induced as a result of vibrations, are reduced perpendicularly to the bending direction due to the selected high stiffness.

### BRIEF DESCRIPTION OF THE DRAWINGS

Preferred exemplary embodiments of the present invention are explained in greater detail below with reference to the figures in which corresponding elements are provided with matching reference numerals.

FIG. 1 shows a hydraulic device which is designed as a fuel injection system and which includes at least one component according to one possible embodiment in an extracted schematic illustration.

FIG. 2 shows an extracted schematic section through a component according to a first exemplary embodiment.

FIG. 3 shows an extracted schematic section through a component according to a second exemplary embodiment.

FIG. 4 shows an extracted a schematic section through a component according to a third exemplary embodiment.

FIG. 5 shows an extracted schematic section through a component according to a fourth exemplary embodiment.

FIG. 6 shows an extracted schematic section through a component according to a fifth exemplary embodiment.

FIG. 7 shows a cross section of the component shown in FIG. 2 along the section line denoted by VII according to a sixth exemplary embodiment.

FIG. 8 shows the cross section of a component shown in FIG. 7 according to a seventh exemplary embodiment.

### DETAILED DESCRIPTION OF EXAMPLE EMBODIMENTS

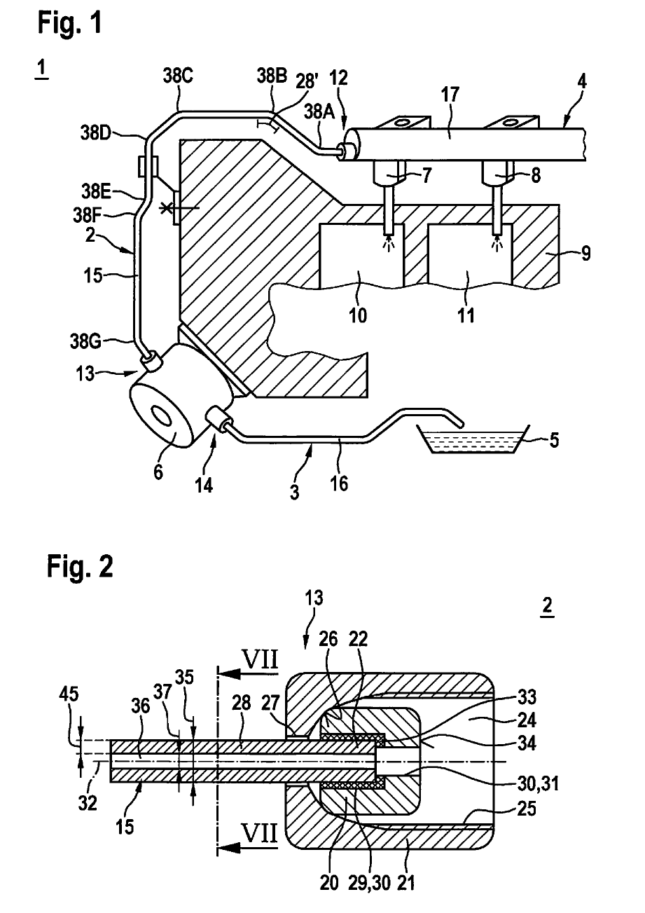

FIG. 1 shows a hydraulic device 1 according to one possible embodiment in which hydraulic device 1 is designed as a fuel injection system 1 in an extracted schematic illustration. Hydraulic device 1 may in particular serve as a high-pressure fuel injection system 1 for internal combustion engines. In another advantageous application, hydraulic device 1 is designed as a hydraulic high-pressure device 1. In general, hydraulic high-pressure device 1 is also suitable for other applications. Hydraulic device 1 includes multiple components 2, 3, 4, a tank 5, a pump 6 which is designed here as a high-pressure pump 6, and multiple fuel injectors 7, 8, only injectors 7, 8 being illustrated in the extracted illustration. In this case, hydraulic device 1 is situated in an extracted and schematically illustrated internal combustion engine 9. Injectors 7, 8 are assigned to combustion chambers 10, 11 of internal combustion engine 9.

Components 2, 3 are designed as fluid lines 2, 3 in this specific embodiment. Here, fluid lines 2, 3 are used as fuel lines 2, 3. Fuel line 2 is connected, on the one hand, at an interface 12 designed as a connecting point 12 and, on the other hand, at an interface 13 designed as a connecting point 13 to high-pressure pump 6. Fluid line 3 is, on the one hand, connected at an interface 14 designed as a connecting point 14 to high-pressure pump 6 and, on the other hand, guided into tank 5. Components 2, 3 each have a tubular base body 15, 16. Fuel distributor 4 has a tubular base body 17 and is designed as a fuel distribution rail 4 in this exemplary embodiment. During operation, fuel is drawn by high-pressure pump 6 from tank 5 via fluid line 3 and delivered into fuel distribution rail 4 via fluid line 2 under high pressure. The highly pressurized fuel stored in fuel distribution rail 4 may then be injected into combustion chambers 10, 11 via injectors 7, 8. High pressures of the fuel in particular allow for an improved injection which results in an improved combustion and thus improved exhaust gas values.

In this exemplary embodiment, injectors 7, 8 are fastened to fuel distribution rail 4 without additional fluid lines, i.e. via cups or the like, for example. In one modified embodiment, fluid lines may, however, also be provided which are designed correspondingly to fluid line 2, for example, in order to connect injectors 7, 8 to fuel distribution rail 4.

FIG. 2 shows an extracted schematic section through a component 2 of hydraulic device 1 illustrated in FIG. 1 according to a first exemplary embodiment, component 2 being designed as fluid line 2, in particular fuel line 2. In this figure and in the following figures, the design of a component is described using the example of component 2. It is understood that component 3 may be designed in a corresponding manner. Furthermore, the described embodiment may also be used at least in parts in other components having a tubular base body, such as component 4 having tubular base body 17, in a correspondingly modified form.

Component 2 includes tubular base body 15, a connecting element 20, and a fastening element 21. In this way, interface 13 which is designed as connecting point 13 may be implemented at an end 22 of tubular base body 15. However, such additional elements 20, 21 are not necessarily provided in modified embodiments and it is also possible for one or multiple other elements to be provided at end 22 or at another point of tubular base body 15.

Fastening element 21 includes a recess 24 which is designed at least sectionally as bore 24 including a female thread 25. In this exemplary embodiment, female thread 25 allows for fastening element 21 to be screwed in at high-pressure pump 6.

Recess 24 has a beveled base 26 through which a supporting surface 26 is formed at fastening element 21. Base 26 is open at a through opening 27 which is formed as a through bore 27. Here, a part 28 of tubular base body 15 extends through through opening 27 into recess 24. Here, there is moreover an operative connection between base body 15 and supporting surface 26 at fastening element 21 via connecting element 20. Connecting element 20 has a recess 29. Recess 29 is an integral part of a stepped bore 30. In this exemplary embodiment, recess 29 is cylinder-shaped, a section 31 which adjoins recess 29 also being cylinder-shaped, but having a reduced diameter. In this exemplary embodiment, part 28 is designed along a straight longitudinal line 32 at least in the illustrated section. Connecting element 20 and fastening element 21 are aligned with regard to straight longitudinal line 32 and are additionally formed rotationally symmetrically with regard to longitudinal line 32 in this exemplary embodiment. A gap between end 22 and connecting element 20 which is also rotationally symmetric with regard to longitudinal line 32 and which is initially present during a manufacturing process, is filled with a connecting material 33 in this exemplary embodiment. Connecting material 33 may be a solder 33 or a glue 33. In one modified embodiment, the connection may also be established by welding, so that a weld seam 33 results instead of connecting material 33. Other modifications are furthermore conceivable in which a form-locked and/or a force-fitted connection is implemented. For example, a form-locked connection may be established by crimping, folding or reshaping.

In this exemplary embodiment, the connection between end 22 and connecting element 20 is implemented as a high-pressure tight connection. In this way, a front side 34 of connecting element 20 may be used to achieve a sealing with regard to a counterpart at high-pressure pump 6 directly or via a suitable sealant. Numerous modifications are conceivable here. For example, a circumferential cutting edge may also be implemented at front side 34 in order to form a copper sealing ring, for example. In such a case, connecting element 20 is preferably formed from a sufficiently hard material with regard to the copper ring, for example.

At least part 28 and here, for example, also a part 28′ of base body 15 is formed from a duplex steel. In one modified embodiment, the material for part 28 may also be based on a duplex steel, a portion of a different steel or of different metals being added, for example, to form the material.

In general, part 28 of base body 15 is thus made from a material which is based on at least one duplex steel. The above-named possible embodiments also apply accordingly to the other described exemplary embodiments.

In this exemplary embodiment, part 28 is designed as a connecting part 28. This results in a particularly good connectability to connecting element 20. Connecting element 20 may also be formed from a material which is based on at least one duplex steel depending on the application and design.

However, another material, in particular an austenitic steel may also be used for connecting element 20. The same applies to fastening element 21. Connecting element 20 and/or fastening element 21 may also be manufactured from a non-corrosion-resistant steel or from a non-corrosion-resistant material, for example, a suitable anti-corrosion coating, i.e., a coating which prevents corrosion, being preferably provided. Specifically, for fastening element 21, the implementation from a non-corrosion-resistant material, in particular steel, is a preferred approach which is cost-effective among other things.

In this exemplary embodiment, a section 22 of part 28, i.e. end 22, of base body 15 is inserted into recess 29 of connecting element 20. This results in high mechanical strength. This is achieved, on the one hand, through the large-scale embodiment of connecting material 33 at both its boundary surfaces toward end 22 and toward connecting element 20 or through correspondingly large implementations of a welded joint or the like. On the other hand, the connection is relieved from occurring transverse forces which occur radially to longitudinal line 32. As a result, other embodiments are also conceivable in which a connection may be established by folding or a different type of reshaping, for example.

To install component 2 at high-pressure pump 6, fastening element 21 may be screwed onto a corresponding counterpart at high-pressure pump 6. In this case, connecting element 20 is pressed against the counterpart, and the connection is established. The tensile forces acting on tubular base body 15 along longitudinal line 32 are supported via connecting material 33 or the like and connecting element 20 is supported at fastening element 21 in a corresponding manner. An additional mechanical protection in the case of occurring external transverse forces is moreover provided via through opening 27 which makes possible a radial support of part 28 in the case of a correspondingly narrow design. Even undesirable bendings of tubular base body 15 may then occur at least essentially only outside of fastening element 21, so that the connection via connecting material 33 or the like is not impaired.

Tubular base body 15 has an external geometry 35 which is predefined as a circular external geometry 35 in this exemplary embodiment. With regard to its interior space 36, tubular base body 15 furthermore has an opening cross section 37 which is predefined as a circular opening cross section 37 in this exemplary embodiment. At least in the section illustrated in FIG. 2, interior space 36 is cylinder-shaped. However, bendings 38A through 38G may also be provided, as illustrated in FIG. 1, for example. Such bendings 38A through 38G may be implemented having suitable curvatures, in particular curvature radiuses, and also as kinks 38A through 38G in the limit case. Such bendings 38A through 38G are examples of possible deformations 38A through 38G of tubular base body 15 along its longitudinal line 32.

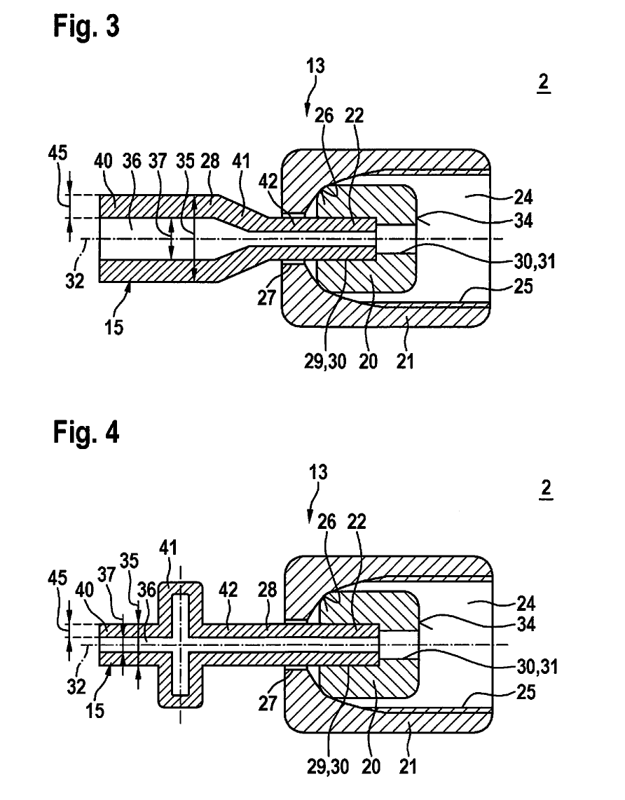

FIG. 3 shows an extracted schematic section through a component 2 according to a second exemplary embodiment. In this exemplary embodiment, tubular base body 15 has a section 40, a section 41 adjoining section 40, and a section 42 adjoining section 41 and leading to end 22. In section 42, tubular base body 15 has a smaller external geometry 35, in particular a smaller external diameter 35, and a smaller opening cross section 37, in particular a smaller inner diameter 37, than in section 40. In section 41, a uniform transition from the geometry in section 40 to the geometry in section 42 takes place along longitudinal line 32. In one modified application, a step 41 may also be provided in section 41.

In this embodiment, a large opening cross section 37 may be achieved via a large section 40, so that a sufficiently minor throttling effect is implemented. This results in an improved fluid conveyance.

At the same time, an advantageous connectability is made possible between end 22 and connecting element 20. This connectability may be implemented in one possible manner, as described based on FIG. 2, for example. However, end 22 may also be pressed in.

FIG. 4 shows an extracted schematic section through a component 2 according to a third exemplary embodiment. In this exemplary embodiment, external geometry 35 and opening cross section 37 in sections 40 and 42 are predefined to match at least essentially. In section 41, however, a locally changed geometry 41 is implemented. Such a locally changed geometry 41 may be implemented axially or rotationally symmetrically with regard to longitudinal line 32. However, asymmetric embodiments are also conceivable. On the one hand, a locally changed geometry 41 allows for the hydraulic properties to be coordinated in order to dampen the pressure pulsations running along longitudinal line 32, for example. On the other hand, such locally altered geometries 41 may also relate to attaching a sensor, in particular a pressure sensor, or connecting an injector 7, 8 in another embodiment, as is expedient, for example, in the case of component 4 which is implemented as fuel distribution rail 4.

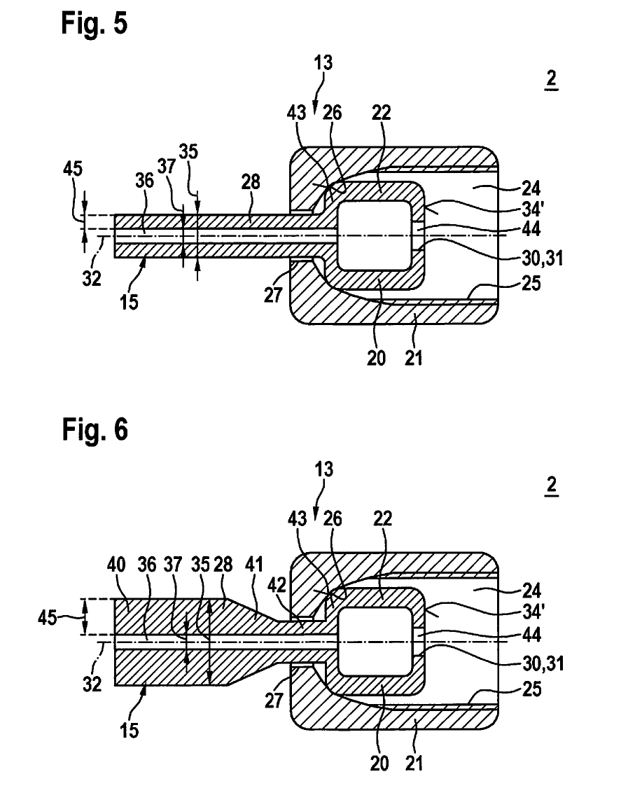

FIG. 5 shows an extracted schematic section through a component 2 according to a fourth exemplary embodiment. In this exemplary embodiment, connecting element 20 may be dispensed with. For this purpose, end 22 of part 28 of tubular base body 15 is designed having an enlarged external geometry 35 as well as having an enlarged opening cross section 37. This makes it possible for end 22 to be supported in an area 43 at supporting surface 26 of fastening element 21. Such a design is also particularly advantageous in the case of component 3 illustrated in FIG. 1. Since component 3 includes an interface 14 only at one end, there is the possibility of first forming end 22 and then adding fastening element 21 on tubular base body 15. This design may correspondingly also be implemented in component 2 illustrated in FIG. 1 at one interface 12, 13, while a design including a connecting element 20 is implemented at other interface 12, 13, as described based on FIG. 2, for example.

Moreover, a front side 34′, in which an opening 44 is provided, is formed at end 22 as a result of enlarged external geometry 35.

FIG. 6 shows an extracted schematic section through a component 2 according to a fifth exemplary embodiment. In this exemplary embodiment, an end 22 is provided having an enlarged external geometry 35, as correspondingly described based on FIG. 5. In this exemplary embodiment, opening 44 is moreover designed having an opening cross section which is greater than opening cross section 37 of interior space 36. This allows for a hydraulic coordination. In one modified embodiment, the opening cross section of opening 44 may also be smaller or equally sized as opening cross section 37 of interior space 36.

In addition, sections 40, 41, 42 are provided at tubular base body 15.

In the case of the exemplary embodiments described based on FIGS. 2 through 5, a wall thickness 45 is at least approximately constant along longitudinal line 32 or changed to at least such a limited extent that, as illustrated in FIG. 3, a variation of opening cross section 37 as well as external geometry 35 is possible along longitudinal line 32 across sections 40, 41, 42.

In contrast thereto, wall thickness 45 described in the fifth exemplary embodiment based on FIG. 6 is changed across sections 40, 41, 42 to such an extent that opening cross section 37 of interior space 36 is constant along longitudinal line 32 up to end 22. This means in particular that a change in wall thickness 45 across section 41 results correspondingly to the change in external geometry 35. Opening cross section 37 is then enlarged at end 22.

In one modified embodiment, it is also possible that a variation of wall thickness 45 is also implemented at end 22, which may in particular be such that opening cross section 37 of interior space 36, potentially including opening 44, does not change along longitudinal line 32. It is furthermore understood that other combinations are also conceivable, for example instead of end 22 having enlarged external geometry 35, such as the one illustrated in FIG. 6, a connecting element 20 may be used, as illustrated based on FIG. 2 or 3 for example.

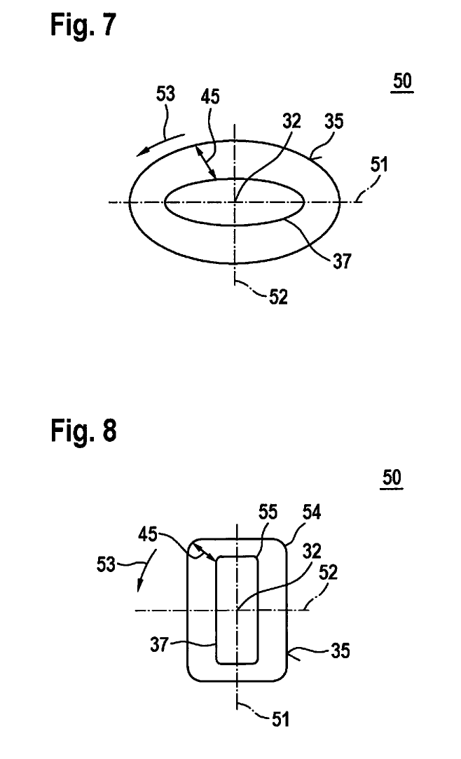

FIG. 7 shows a cross section 50 of component 2 shown in FIG. 2 along the section line denoted by VII according to a sixth exemplary embodiment. In this exemplary embodiment, external geometry 35 with regard to axes 51, 52 is modified from a rotationally symmetric implementation with regard to longitudinal line 32. In this exemplary embodiment, axes 51, 52 are oriented radially to longitudinal line 32, so that they intersect at longitudinal line 32. In this exemplary embodiment, a right angle is furthermore predefined between axes 51, 52. In this exemplary embodiment, the modification takes place in such a way that external geometry 35 is greater at axis 51 than at axis 52. In particular, opening cross section 37 and/or external geometry 35 may have an at least approximately elliptical design. Other round designs of opening cross section 37 and/or of external geometry 35 are, however, also advantageous.

In this exemplary embodiment, a variation of wall thickness 45 is furthermore implemented along a circumferential direction 53. The design of cross section 50, such as the one illustrated in FIG. 7, may also refer to a part 28′ of tubular base body 15 which is situated at bending 38B, for example. Due to the non-symmetric design of cross section 50 and/or the corresponding variations of wall thickness 45, different stiffnesses are achieved in different radial directions, in particular at axes 51, 52, thus facilitating a bending and, at the same time, allowing for a high stiffness perpendicular to the bending.

FIG. 8 shows cross section 50 of component 2 shown in FIG. 7 according to a seventh exemplary embodiment. In this exemplary embodiment, a geometry of cross section 50, is implemented which is not rotationally symmetric with regard to longitudinal line 32, as is the case in the exemplary embodiment described based on FIG. 7. Here, external geometry 35 and opening cross section 37 are based on a rectangular shape, edge roundings 54, 55 being provided. Furthermore, wall thickness 45 may also be varied in a suitable manner. In this embodiment, different stiffnesses may also be predefined in different directions, in particular along axes 51, 52.

In this way, advantageous geometries of component 2 and, correspondingly, of components 3, 4 may be implemented, an advantageous manufacturability as well as advantageous chemical and mechanical properties being implementable at the same time, especially due to the fact that at least one part 28, 28′ of base body 15 is formed from a material based on at least one duplex steel, which includes the case that entire base body 15 is formed from the material based on at least one duplex steel.

A tubular base body 15, 16, 17 may be formed from a seamlessly drawn, tubular component 15, 16, 17. Alternatively, tubular base body 15, 16, 17 may be based on a tight-welded sheet metal. For this purpose, a planar sheet metal, for example, may be bent and tight-welded correspondingly to desired cross section 50. A tubular base body 15, 16, 17 may in particular have a round or a rectangular cross section 50.

The present invention is not limited to the described exemplary embodiments and modifications.

1-11. (canceled)

12. A component of a hydraulic device, comprising:
a tubular base body, wherein at least one part of the base body is formed from a material based on at least one duplex steel.

13. The component as recited in claim 12, wherein the component is a fluid line of a hydraulic high-pressure device.

14. The component as recited in claim 12, wherein the component is a fluid line of a fuel injection system for an internal combustion engine.

15. The component as recited in claim 12, wherein at least one part of the base body is formed at least essentially from at least one duplex steel.

16. The component as recited in claim 12, wherein at least one part of the base body which is formed from the material based on at least one duplex steel is one of a connecting part or a closure part.

17. The component as recited in claim 12, wherein at least one part of the base body which is formed from the material based on at least one duplex steel is formed at an end of the tubular base body.

18. The component as recited in claim 12, wherein a connecting element is provided which is connected to the part of the base body which is formed from the material based on at least one duplex steel.

19. The component as recited in claim 12, wherein a connecting element is provided which is connected by at least one of soldering, welding, form-locked reshaping, folding and gluing, to the part of the base body which is formed from the material based on at least one duplex steel.

20. The component as recited in claim 18, wherein the connecting element has a recess into which the at least one section of the part of the base body which is formed from the material based on at least one duplex steel is inserted.

21. The component as recited in claim 20, wherein the connecting element has a stepped bore that includes the recess of the connecting element.

22. The component as recited in claim 20, wherein the connecting element is formed from a material which is based on at least one duplex steel or an austenitic steel.

23. The component as recited in claim 20, wherein a fastening element is provided and the connecting element is supported at the fastening element along a longitudinal line of an interior space of a part of the tubular base body which is connected to the connecting element.

24. The component as recited in claim 12, wherein the part of the tubular base body which is formed from the material based on at least one duplex steel is implemented having at least one of: (i) a locally varying cross section, (ii) an opening cross section opening along a longitudinal line of an interior space of the tubular base body, and (iii) an external geometry varying along a longitudinal line of an interior space of the tubular base body.

25. The component as recited in claim 12, wherein the part of the base body which is formed from the material based on at least one duplex steel has at least one of: (i) at least sectionally a round external geometry, (ii) at least sectionally a polygonal external geometry, (iii) at least sectionally an interior space having a round opening cross section, and (iv) at least sectionally an interior space having a polygonal opening cross section.

26. The component as recited in claim 12, wherein the part of the base body which is formed from the material based on at least one duplex steel is bent at least sectionally along a longitudinal line of an interior space of the tubular base body.

27. The component as recited in claim 12, wherein the part of the base body which is formed from the material based on at least one duplex steel has at one end at least one enlarged external geometry and the end is supported at a supporting surface of a fastening element in an area of the enlarged external geometry.

28. The component as recited in claim 12, wherein at least one of: (i) the tubular base body is formed from a seamlessly drawn, tubular component, (ii) the tubular base body is based on a tight-welded sheet metal, and (iii) the tubular base body has one of a round or a rectangular cross section.

29. A high-pressure device or a fuel injection system, comprising:
at least one component including a tubular base body, wherein at least one part of the base body is formed from a material based on at least one duplex steel.
